(19) United States
(12) Patent Application Publication
(10) Pub. No.: US 2021/0336960 A1
(43) Pub. Date: Oct. 28, 2021

(54) A System and a Method for Monitoring Traffic Flows in a Communications Network

(71) Applicants: DRIVENETS LTD., Raanana (IL); AT&T Services, Inc., Dallas, TX (US)

(72) Inventors: Evgeny SANDLER, Herzliya (IL); Amir KRAYDEN, Hertzelia (IL); Kfir GOLLAN, Tel Aviv (IL); Hagai SELA, Sde Warburg (IL)

(21) Appl. No.: 17/311,087

(22) PCT Filed: Nov. 16, 2019
(86) PCT No.: PCT/IL2019/051248

§ 371 Date: Jun. 4, 2021

Related U.S. Application Data
(60) Provisional application No. 62/777,275, filed on Dec. 10, 2018.

(51) Int. Cl. H04L 29/06

(52) U.S. Cl. CPC H04L 63/101; H04L 63/20; H04L 63/1458; H04L 63/1425

(57) ABSTRACT

A network element and a method are configured to monitor a plurality of traffic flows conveyed in a communications network, wherein the network element comprises: at least one packet processor configured to support ACL functionality, and at least one CPU configured to track traffic flows and to export statistical data.

### TECHNICAL FIELD

The present disclosure relates generally to the field of networking, and in particular, to metering of network flows of communications' traffic.

### Glossary

ASIC—Application-Specific Integrated Circuit
ACL—Access Control List.
BGP—Border Gateway Protocol.
CPU—central processing unit.
DDoS—distributed denial-of-service
Dst-IP—destination IP (address)
DSCP—differentiated services code point
FIB—forwarding information base table.
FPGA—field-programmable gate array
Src-IP—source IP (address)
TCP—Transmission Control Protocol
TTL—Time to live
7-tuple parameters—A network flow is defined as a unidirectional sequence of packets between given source and destination endpoints. Traditional NetFlow uses a 7-tuple of source and destination IP address, transport layer port numbers, IP Protocol, Type of Service (ToS), and the input interface port to uniquely identify flows, whereas egress NetFlow uses the output interface.

### BACKGROUND

Flow monitoring has become a mandatory functionality that needs to be implemented in modern networks. Network operators are required to collect information associated with the traffic being conveyed within their networks at a very high resolution and for various purposes and applications. Some examples of such applications are:
DDoS flows detection;
Traffic Engineering;
Network visibility; and
Billing.

There are different flow monitoring protocols that have been defined for use in the industry. The most known protocols are NetFlow and IPFIX. In general, implementing flow monitoring mechanisms requires maintaining a list of known active flows in a table which is typically referred to as “Flow cache”, while a flow is often defined as a 7-tuple set of packets, i.e. a set of packets that share the same 7 parameters, namely, In-Port, Src-IP, Dst-IP, DSCP/TC, IP-Protocol, Src-L4-Port and Dst-L4-Port.

A flow monitor is typically used to classify ingressing packets into respective flows, where each of the received packet's 7-tuple parameters are compared against a list of known active flows in the “flow cache” table. If a received packet cannot be identified as a packet that belongs to any one of the currently active flows in the “flow cache”, a new flow would be added to the “flow cache” table.

The flow monitoring functionality typically involves collecting statistics associated with each of the active flows. Certain examples of parameters whose statistics may be recorded by traffic metering for each of the active flows are:
In-packets;
In-bytes;
Start of flow time;
End of flow time;
List of observed TCP flags;
Next hop address/interface;
Maximum/minimum observed packet size; and
Maximum/minimum observed TTL value.

Last but not least, flow monitoring functionality further includes aging functionality, whereby traffic flows are removed from the flow cache table upon becoming inactive flows. Usually the criterion for a flow to become an inactive flow, can be a predefined period of time that has lapsed since time at which the last packet associated with that flow was received, or when a packet associated with a certain flow was received with an “end-of-flow” indicator (e.g. TCP FIN flag).

Since each received packet should be inspected by a network device for flow monitoring, it is vital that flow monitoring functionality be implemented in a hardware device (e.g. ASCI or FPGA chip). However, not all network devices are based on packet processors that support flow monitoring or equipped with an in-line FPGA device for implementing such a functionality. In such a case an operator may decide to implement flow monitoring mechanism as a software logic running on a local CPU of the network device. A copy of received packet may be sent to the local CPU for software-based flow monitoring inspection. Since local CPU cannot handle all packets received by the packet processor, a packet sampling method is usually applied to overcome this problem, i.e. not all of the received packets are forwarded to the local CPU, and instead, only part of the packets are forwarded to the local CPU according to a sample rate that may be configured by the operator. The drawback of the packet sampling method is the fact that most of the traffic will not be measured, and consequently the flow statistics will represent only a fraction of the traffic flow.

The present disclosure seeks to provide a solution which solves the above described hurdles associated with traffic flow monitoring.

### SUMMARY

The disclosure may be summarized by referring to the appended claims.

It is an object of the present disclosure to provide a novel network element and a software, operative in communications network that enable monitoring of known traffic flows.

It is another object of the disclosure to provide a novel method and a software to perform traffic metering of existing (known) flows at the packet processor's forwarding rate.

It is another object of the disclosure to provide a novel method and a software directed to speed-up detection of new (unknown) flows by implementing a “flow sampling” approach.

Other objects of the present disclosure will become apparent from the following description.

According to a first embodiment of the present disclosure, there is provided a network element (i.e. a physical, non-transitory network element) configured to monitor a plurality of traffic flows conveyed in a communications network, wherein the network element comprises:
(i) at least one packet processor configured to support ACL functionality; and
(ii) at least one CPU configured to carry out:
   a. tracking traffic flows; and
   b. exporting statistical data.

According to another embodiment, the at least one processor (e.g. a packet processor) is further configured to classify a plurality of incoming packets by their respective known traffic flows. Preferably, classifying a plurality of incoming packets into their respective known traffic flows is achieved by using a table associated with the ACL functionality.

The term “known traffic flow” as used herein throughout the specification and claims is used to denote a traffic flow that has already been recognized by a network element which receives packets that belong to that traffic flow, and wherein all packets that belong to a specific traffic flow are associated with delivery-related parameters that are common to all these packets.

The term “unknown traffic flow” as used herein throughout the specification and claims is used to denote a traffic flow that has not yet been recognized by a network element which receives packets that belong to that traffic flow or a traffic flow which is not active when a packet is received at the network element, and wherein all packets that belong to a specific unknown traffic flow are associated with delivery-related parameters that are common to all these packets.

According to another embodiment, the ACL functionality is obtained by associating a plurality of ACL rules, each associated (e.g. representing) a known traffic flow, and a default ACL rule which is associated with (e.g. represents) all unknown traffic flows.

By yet another embodiment, the default rule is configured to initiate generation and forwarding of a copy of a packet that belongs to an unknown traffic flow to the at least one CPU, so that they can be learned by a flow tracking application that resides at the at least one CPU.

In accordance with another embodiment, a packet that is in conformity with one of a plurality of ACL rules representing a known traffic flow, is determined to be a packet that that belongs to the known traffic flow represented by that one of the plurality of ACL rules.

According to still another embodiment, the one CPU is configured to track traffic flows on a periodical basis and to retrieve information from the table associated with the ACL functionality that relates to traffic flows' life cycles, and possibly to export statistical data by a) initiating generation of packets that comprise information relating to inactive traffic flows and b) initiating export of the packets towards a remote device that is operative to collect data that relates to the inactive traffic flows (a device configured to enable collecting of statistical data).

In accordance with another embodiment, the network element is further configured to monitor a flow rate of a known traffic flow, at a rate which is essentially equal to a rate at which packets that belong to that known traffic flow, are received by the network element. In other words, according to this embodiment of the present disclosure, each packet that will be received by the network element which is associated with one of the flows already known to that network element, will be taken into account (e.g. will be counted as one of the traffic flow's packets for calculating the traffic flow statistics).

According to another embodiment, the monitoring of a flow rate of an unknown traffic flow is carried out in accordance with a pre-defined traffic flow sampling rate, whereby information that relates only to a part of newly detected traffic flows (i.e. the unknown traffic flows) is taken into account (considered), and wherein a number of newly detected traffic flows whose information is taken into account, depends on the pre-determined traffic flow sampling rate. The pre-defined traffic flow sampling rate may optionally be configured by the user.

By still another embodiment each of the plurality of traffic flows is characterized in that:
a. each of the plurality of traffic flows comprises a plurality of packets that comprise identical forwarding related parameters (e.g. In-Port, Src-IP, Dst-IP, IP-Protocol etc.)
b. each of the plurality of traffic flows ends after a pre-defined period of time has lapsed, wherein that pre-defined period of time extends from a time at which the last packet associated with a respective traffic flow was received and/or a packet that is associated with a respective traffic flow comprises an end-of-flow characteristic (e.g. TCP FIN flag).
c. each of the plurality of traffic flows starts when a packet associated with a respective traffic flow has been first detected and/or when a packet associated with a respective traffic flow has been first detected after that respective traffic flow had been determined as a traffic flow that had been ended.

According to another embodiment, the network element is further configured to maintain statistical data characterizing each known traffic flow by using an ACL engine comprised in the packet processor. This embodiment allows that no software mechanism would be required for implementing statistics maintenance per each of the traffic flow.

In accordance with another embodiment, the packet processor of the network element is configured to perform a traffic flow learning (e.g. detection of beginning of a new traffic flow) by using the ACL functionality and affecting a packet snooping mechanism, and wherein a determination that a packet does not belong to any of the known currently active flows, is taken by that packet processor. Preferably, upon detecting the beginning of a new traffic flow, the at least one CPU logic is configured to add a new active traffic flow to a flow cache table comprised thereat.

By yet another embodiment, the network element is further configured to determine which flows have become inactive, and optionally to remove such inactive flows from the “flow cache” table. Preferably, the determination made while taking into consideration updated information derived from the flow cache table stored at the local CPU and/or stored as an ACL rule at the processor, thereby enabling the removal of the respective ACL rule from the flow cache table stored at the local CPU.

According to another aspect of the present disclosure there is provided a method for monitoring a plurality of traffic flows conveyed by a network element operative in a communications network, wherein the network element comprises:
(i) at least one packet processor configured to support ACL functionality; and
(ii) at least one CPU configured to carry out:
   a. tracking of traffic flows; and
   b. exporting statistical data,
      and wherein the method comprises the steps of:

receiving a plurality of packets at the network element;

for each of the plurality of the packets, determining whether it belongs to a traffic flow of which a preceding packet has already been received at that network element;

if a packet is determined to belong to an active traffic flow of which a preceding packet has already been received at the network element, and wherein at least one parameter characterizing the active traffic flow is associated with a rule stored in an ACL table comprised in the at least one packet processor, the method comprises:
retrieving statistical data associated with packets determined as packets that belong to the active traffic flow, and
applying the retrieved statistical data for monitoring the active traffic flow;

if a packet is determined not to belong to any active traffic flow of which a preceding packet has already been received at the network element, the method comprises:
generating a copy of the packet that does not belong to any active traffic flow of which a preceding packet has already been received at the network element, and forwarding the copy to the at least one CPU;
generating at least one new ACL rule that represents a new traffic flow to which the packet belongs, and wherein the at least one new ACL rule is associated with at least one parameter characterizing the new traffic flow;
storing the at least one new ACL rule at an ACL table comprised at the at least one packet processor;
determining which of a plurality of proceeding packets arriving to the network element belong to the new traffic flow, wherein the packets that belong to the new traffic flow are packets which are in conformity with the at least new ACL rule; and
retrieving statistical data associated with packets determined as packets that belong to the new traffic flow and applying the retrieved statistical data for monitoring the new traffic flow.

According to another embodiment of this aspect of the disclosure, the percentage of new traffic flows for which ACL rules are generated, from among the total number of new traffic flows arriving at that network element, decreases along with increasing the number of new traffic flows arriving at the network element.

By still another aspect of the present disclosure, there is provided a non-transitory computer readable medium storing a computer program for performing a set of instructions to be executed by one or more computer processors, the computer program is adapted to perform a method for monitoring a plurality of traffic flows conveyed by a network element operative in a communications network, wherein the network element comprises:
(i) at least one packet processor configured to support ACL functionality; and
(ii) at least one CPU configured to carry out:
   a. tracking of traffic flows; and
   b. exporting statistical data, and wherein the method comprises the steps of:
      upon receiving a plurality of packets at the network element determining whether it belongs to a traffic flow of which a preceding packet has already been received at the network element;
      if a packet is determined to belong to an active traffic flow of which a preceding packet has already been received at the network element, and wherein at least one parameter characterizing the active traffic flow is associated with a rule stored in an ACL table comprised in the at least one packet processor,
         retrieving statistical data associated with packets determined as packets that belong to the active traffic flow, and
         applying the retrieved statistical data for monitoring the active traffic flow;

if a packet is determined not to belong to any active traffic flow of which a preceding packet has already been received at the network element,
generating a copy of the packet that does not belong to any active traffic flow of which a preceding packet has already been received at the network element, and forwarding the copy to the at least one CPU;
generating at least one new ACL rule that represents a new traffic flow to which the packet belongs, and wherein the at least one new ACL rule is associated with at least one parameter characterizing the new traffic flow;
storing the at least one new ACL rule at an ACL table comprised at the at least one packet processor;
determining which of a plurality of proceeding packets arriving to the network element belong to the new traffic flow, wherein the packets that belong to the new traffic flow are packets which are in conformity with the at least new ACL rule; and
retrieving statistical data associated with packets determined as packets that belong to the new traffic flow and applying the retrieved statistical data for monitoring the new traffic flow.

### BRIEF DESCRIPTION OF THE DRAWINGS

The accompanying drawings, which are incorporated herein and constitute a part of this specification, illustrate several embodiments of the disclosure and, together with the description, serve to explain the principles of the embodiments disclosed herein.

FIG. 1. illustrates a schematic overview of a network element configured to enable traffic flow monitoring, construed in accordance with an embodiment of the present invention;

FIG. 2. illustrates a schematic overview of a network element for handling a traffic flow which has not yet been recognized by the packet processor, construed in accordance with another embodiment of the present invention;

FIG. 3. illustrates a schematic overview of a network element for monitoring an active traffic flow which has already been recognized by the packet processor, construed in accordance with an embodiment of the present invention; and

FIG. 4. illustrates a schematic overview of a network element configured to monitor active flows and to export statistical information on non-active traffic flows, construed in accordance with another embodiment of the present invention.

### DESCRIPTION OF EXEMPLARY EMBODIMENTS

Some of the specific details and values in the following detailed description refer to certain examples of the disclosure. However, this description is provided only by way of example and is not intended to limit the scope of the invention in any way. As will be appreciated by those skilled in the art, the claimed method and device may be implemented by using other methods that are known in the art per se. In addition, the described embodiments comprise different steps, not all of which are required in all embodiments of the invention.

High performance network device data plane is typically based on packet processors which may be implemented in a form of an ASIC or an FPGA. Packet processors have multiple network interfaces, and are configured to take a decision on how to forward a packet received at the network element, at which the packet processor is installed. The decision may be taken by that packet processor according to the forwarding information base table (FIB). In addition to the FIB tables, packet processors maintain other tools. One of such other tools is an Access Control List (ACL) which is a table that includes a plurality of rules defining required actions to be taken for packets that match specific criteria.

Examples for these actions may be dropping a matched packet, logging a packet or redirecting a packet to a specific interface (a.k.a. ACL-based Forwarding). The rule matching criteria are often implemented as a set of packet's header parameters and ingress interface (the interface at which that packet was received). Some examples of such rule matching criteria are: packets having a specific destination IP address, packets having a specific source L4 port, etc. Once a packet is determined to be a packet that matches a specific rule, it is typically counted, thereby enabling the operator to obtain information on the number of times in which a specific rule was applied to the incoming traffic.

In addition to the at least one packet processor described above, a network element of the present disclosure further comprises at least one CPU that is configured to execute a Forwarding Engine application. A Forwarding Engine application is responsible to maintain the FIB, ACL and any other applicable packet processor resources according to the routing engine directives. The routing engine device may be executed by the same CPU (or by another CPU) as the Forwarding Engine application, and the decision on whether the same CPU will be used for both or not, depends primarily on the system architecture. For example, in distributed systems, a routing engine may be executed on a separate HW dedicated for running routing protocols.

The present disclosure proposes a solution whereby a flow-monitoring functionality is obtained while using a packet processor's ACL block.

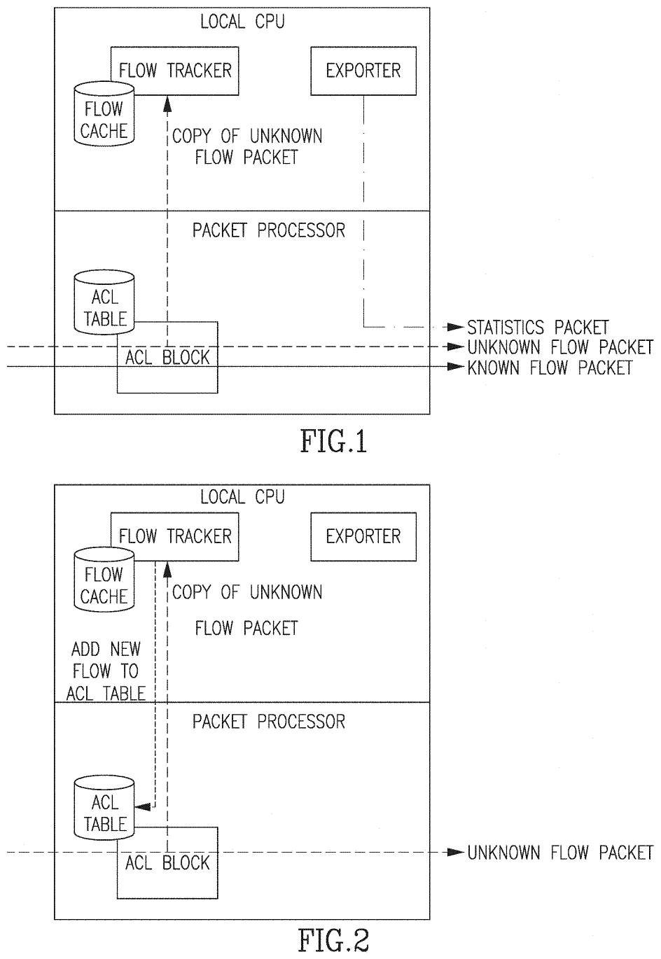

FIG. 1. illustrates a schematic overview of a network element 100 that comprises a packet processor 110 and a local CPU 120, for implementing a flow-monitoring mechanism. Packet processor 110 includes an ACL table 130 which comprises a list of rules, where each of these rules represents a known 7-tuple flow (Ingress Interface, Src-IP, Dst-IP, IP-Protocol, DSCP, Src-L4-Port, Dst-L4-Port). ACL table 130 also maintains rule-matching counters, preferably, a counter per each ACL rule. For example, ACL table 130 may include counters that represent the number of times that packets/octets were matched with a specific 7-tuple flow. Local CPU 120, is configured to execute two software entities—“flow tracker” 140 and “exporter” 150. The “flow tracker” entity 140 is configured to add new ACL rules (i.e. new flows) to ACL table 130, to enable collecting statistical data associated with existing ACL rules, and to delete ACL rules that represent inactive flows. In addition, “flow tracker” 140 may maintain a “flow cache” table 160 where flow parameters are stored per each of the known flows. Examples of such flow parameters are: monitored packets/octets that are associated with a certain traffic flow, traffic flow starting time, traffic flow ending time, reason for flow ending, ingress interface, egress interface, source BGP-AS, destination BGP-AS etc.

The “exporter” entity 150 is configured to retrieve traffic flows statistics from “flow tracker” 140, have it encapsulated in a packet to be exported (the packet format may be defined in compliance with the appropriate traffic flow monitoring protocol) and to forward the exported packet to a statistics collector (not shown in this FIG. 1).

FIG. 2. relates to an embodiment whereby a packet that belongs to a traffic flow which has not yet been recognized by the packet processor. In other words, no relevant rule could yet have been included in the ACL table. Thus, FIG. 2 illustrates a schematic overview of a network element 200 that comprises a packet processor 210 and a local CPU 220, for implementing a flow-monitoring mechanism of handling a packet that is associated with an unknown flow. ACL table 230 includes a default rule which is configured to initiate generation of a copy of a packet that does not match any of the rules associated with the known traffic flows, hence that packet belongs to an unknown traffic flow, and the packet is forwarded to local CPU 220 (e.g. to flow tracker 240 which is comprised in CPU 220). When a packet that belongs to an unknown traffic flow arrives, ACL block 270 performs a lookup for the packet in the ACL table 230. Since no rule has yet been set for the specific traffic flow (i.e. as it is an unknown flow) to which the packet belongs, the only rule that could match that packet, is a pre-defined default rule. The packet is forwarded in accordance with a decision taken by packet processor 210 in view of information retrieved from the FIB list, while a copy of that packet would be forwarded to the local CPU 220 (according to the default rule). The flow tracker application 240 receives the copy of the packet, generates a new ACL rule that represents a new traffic flow (according to the packet's 7-tuple parameters) and conveys the new ACL rule to ACL table 230 for its storage thereat. In addition, flow tracker 240 creates a new entry in flow cache table 260 and updates all known parameters that characterize the new traffic flow (e.g. flow starting time, egress IF according to the FIB, Src/Dst BGP-AS etc.) Thereafter, all the consecutive packets that relate to the same traffic flow, will be considered by the ACL block as packets that belong to a known traffic flow.

The rate of arriving packets that belong to new traffic flows may be too high for tracking the packets by the flow tracking software entity 240. In order to cope with their high rate, a default ACL rule may be determined so that only part of the packets that belong to unknown traffic flows will be processed. Such an approach is referred to herein as a traffic flow sampling rate mechanism. In other words, only part of the packets that belong to unknown traffic flows will be processed (learned) by the traffic flow tracker 240, so that the parameters associated with a new traffic flow that will be included in a new ACL rule, will be determined only based on a number of new traffic flows which correspond to a pre-determined traffic flow sampling rate, a rate which may be configured by the user. However, it is important to note that in such a case, once a new traffic flow is learned (i.e. once the parameters associated with a traffic flow to which the packet belongs has been established) and a corresponding ACL rule has been established, all proceeding packets that belong to this traffic flow will be considered as packets that belong to a known traffic flow and be counted.

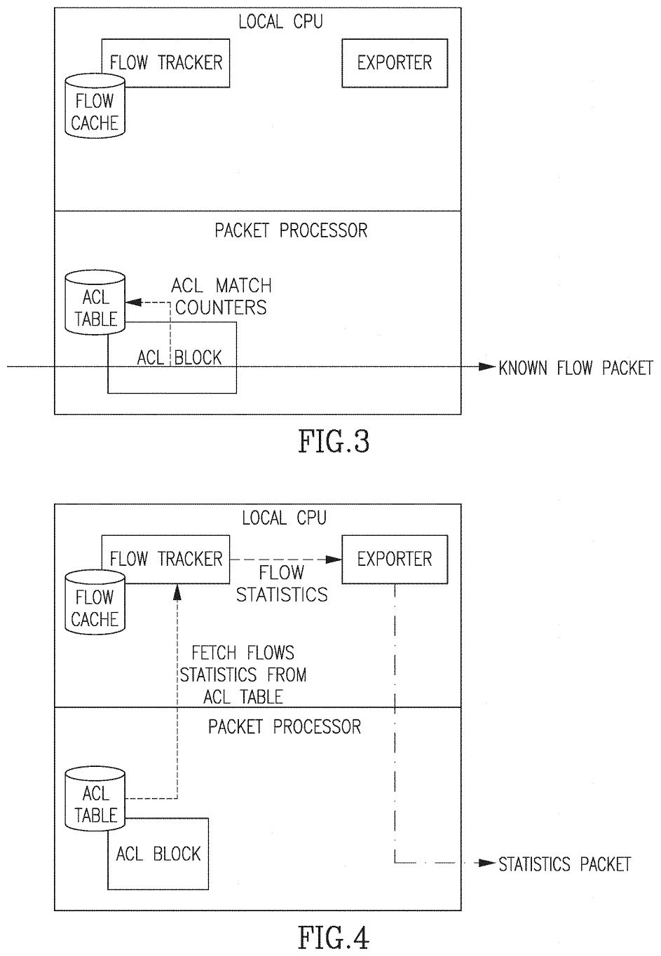

FIG. 3. relates to an embodiment concerning a packet that belongs to a traffic flow which has already been recognized by the packet processor, and is associated with a specific rule stored at the ACL table. FIG. 3 illustrates a schematic overview of a network element 300 that comprises a packet processor 310 and a local CPU 320, for implementing a flow-monitoring mechanism of handling a packet that is associated with a known flow.

In this case, a received packet would undergo an ACL lookup by ACL block 370 and in parallel by the forwarding lookup comprised in the FIB of packet processor 310. Once a lookup match is found to the ACL rule, a rule that represents the traffic flow to which the packet belongs, ACL block 370 will update the counter of packets/octets which is associated with the specific ACL rule that matches the packet's parameters. The packet will then be forwarded to the relevant egress interface in accordance with a determination made by the FIB.

FIG. 4 illustrates a schematic overview of a network element 400 that comprises a packet processor 410 and a local CPU 420, construed in accordance with another embodiment of the disclosure. The process carried out while implementing this embodiment comprises a step of retrieving traffic flows' statistics by traffic flow tracker 440 from ACL table 430 and exporting the statistics retrieved by traffic flow tracker 440 to a remote statistics collector (e.g. a remote server) by exporter 450.

Every pre-determined period of time, or at pre-defined times, traffic flow tracker 440 retrieves statistical data that correspond to each ACL rule from ACL table 430 and updates the flow cache table 460 with pre-defined parameters such as the “number of packets/octets per flow”. The traffic flow tracking entity 440 uses relevant ACL rule statistics to deduce if a known traffic flow is not active any longer. For example, if according to the configuration, a flow cannot be idle for more than 60 minutes, and the last packet of a certain traffic flow is known to be received more than 60 minutes ago, flow tracker 440 would change the state of that specific traffic flow in the flow cache table 460 to “inactive”. In addition, flow tracker 440 will forward the information (e.g. statistical data) regarding each inactive flow to exporter 450, so that this information can be exported to the remote collecting system.

In summary, the solution provided by the present disclosure enables implementing traffic flow monitoring by packet processors which are not designed to support such a flow monitoring functionality. The method provided herein is based on the use of packet processors that comprise an Access Control List (ACL) engine for gathering statistics on active traffic flows (i.e. known traffic flows). Packets associated with unknown traffic flows would be forwarded to a local CPU so that new traffic flows could be added to the flow cache table. A logic for carrying out the addition of these new traffic flows to the flow cache table, may be further modified to be able to handle a larger number of traffic flows by applying a flow sampling mechanism, whereby not all of the packets that are associated with unknown traffic flows are forwarded to the local CPU. By using this mechanism, it is not necessary to add a new unknown traffic flow to the flow cache table upon receiving the first packet of that traffic flow. However, the statistical records for the known active traffic flows are accurate, since all the packets that belong to these known traffic flows are inspected and recorded by the packet processor.

In other words, the solution disclosed by the present disclosure provides network devices (e.g. switches and routers) having the ability to monitor traffic flows by modifying the operation of a standard ACL engine, so that it becomes possible to classify incoming packets into specific 7-tuple flows and to maintain statistics per each identified traffic flow.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A network element configured to monitor a plurality of traffic flows conveyed in a communications network, wherein the network element comprises:
(i) at least one packet processor configured to support ACL functionality; and
(ii) at least one CPU configured to carry out:
a. tracking traffic flows; and
b. exporting statistical data.

2. The network element of claim 1, wherein said at least one processor is further configured to classify a plurality of incoming packets to their respective known traffic flows.

3. The network element of claim 2, wherein said at least one processor is further configured to classify a plurality of incoming packets into their respective known traffic flows is achieved by using a table associated with said ACL functionality.

4. The network element of claim 3, wherein said ACL functionality is obtained by associating a plurality of ACL rules, each representing a known traffic flow, and a default ACL rule which represents all unknown traffic flows.

5. The network element of claim 4, wherein said default rule is configured to initiate generation and forwarding of a copy of a packet that belongs to an unknown traffic flow to said at least one CPU.

6. The network element of claim 4, wherein a packet that is in conformity with one of a plurality of ACL rules representing a known traffic flow, is determined to be a packet that is associated with the known traffic flow represented by said one of the plurality of ACL rules.

7. The network element of claim 3, wherein said one CPU is configured to track traffic flows on a periodical basis and to retrieve information from said table associated with the ACL functionality that relates to traffic flows' life cycles, and to export statistical data by a) initiating generation of packets that comprise information relating to inactive traffic flows and b) initiating export of said packets towards a remote device that is operative to collect data that relates to said inactive traffic flows.

8. The network element of claim 1, further configured to monitor a flow rate of a known traffic flow, at a rate which is essentially equal to a rate at which packets that belong to said known traffic flow are received by said network element.

9. The network element of claim 1, wherein said monitoring of a flow rate of an unknown traffic flow is carried out in accordance with a pre-defined traffic flow sampling rate, whereby information that relates only to a part of newly detected traffic flows is taken into account, and wherein a number of newly detected traffic flows whose information is taken into account, depends on said pre-determined traffic flow sampling rate.

10. The network element of claim 1, wherein each of said plurality of traffic flows is characterized in that:
a. each of said plurality of traffic flows comprises a plurality of packets that comprise identical forwarding related parameters;
b. each of the plurality of traffic flows ends after a pre-defined period of time has lapsed, wherein that pre-defined period of time extends from a time at which the last packet associated with a respective traffic flow was received and/or a packet that is associated with a respective traffic flow comprises an end-of-flow characteristic; and
c. each of the plurality of traffic flows starts when a packet associated with a respective traffic flow has been first detected and/or when a packet associated with a respective traffic flow has been first detected after that respective traffic flow had been determined as a traffic flow that had been ended.

11. The network element of claim 1, wherein said network element is further configured to maintain statistical data characterizing each known traffic flow, by using an ACL engine comprised in said packet processor.

12. A method for monitoring a plurality of traffic flows conveyed by a network element operative in a communications network, wherein the network element comprises:
(i) at least one packet processor configured to support ACL functionality; and
(ii) at least one CPU configured to carry out:
a. tracking of traffic flows; and
b. exporting statistical data,
and wherein said method comprises the steps of:
receiving a plurality of packets at the network element;
for each of the plurality of the packets, determining whether it belongs to a traffic flow of which a preceding packet has already been received at said network element;
if a packet is determined to belong to an active traffic flow of which a preceding packet has already been received at said network element, and wherein at least one parameter characterizing said active traffic flow is associated with a rule stored in an ACL table comprised in said at least one packet processor, said method comprises:
retrieving statistical data associated with packets determined as packets that belong to said active traffic flow, and
applying the retrieved statistical data for monitoring said active traffic flow;
if a packet is determined not to belong to any active traffic flow of which a preceding packet has already been received at said network element, the method comprises:
generating a copy of said packet that does not belong to any active traffic flow of which a preceding packet has already been received at said network element, and forwarding said copy to said at least one CPU;
generating at least one new ACL rule that represents a new traffic flow to which said packet belongs, and wherein said at least one new ACL rule is associated with at least one parameter characterizing said new traffic flow;
storing said at least one new ACL rule at an ACL table comprised at said at least one packet processor;
determining which of a plurality of proceeding packets arriving to said network element belong to said new traffic flow, wherein said packets that belong to said new traffic flow are packets which are in conformity with said at least new ACL rule; and
retrieving statistical data associated with packets determined as packets that belong to said new traffic flow and applying the retrieved statistical data for monitoring said new traffic flow.

13. The method of claim 12, wherein the percentage of new traffic flows for which ACL rules are generated from among the total number of new traffic flows arriving at said network element, decreases along with increasing a number of new traffic flows arriving at said network element.

14. A non-transitory computer readable medium storing a computer program for performing a set of instructions to be executed by one or more computer processors, the computer program is adapted to perform a method for monitoring a plurality of traffic flows conveyed by a network element operative in a communications network, wherein the network element comprises:
(i) at least one packet processor configured to support ACL functionality; and
(ii) at least one CPU configured to carry out:
a. tracking of traffic flows; and
b. exporting statistical data,
and wherein said method comprises the steps of:
upon receiving a plurality of packets at the network element determining whether it belongs to a traffic flow of which a preceding packet has already been received at the network element;
if a packet is determined to belong to an active traffic flow of which a preceding packet has already been received at the network element, and wherein at least one parameter characterizing the active traffic flow is associated with a rule stored in an ACL table comprised in the at least one packet processor,
retrieving statistical data associated with packets determined as packets that belong to the active traffic flow, and
applying the retrieved statistical data for monitoring the active traffic flow;
if a packet is determined not to belong to any active traffic flow of which a preceding packet has already been received at the network element,
generating a copy of the packet that does not belong to any active traffic flow of which a preceding packet has already been received at the network element, and forwarding the copy to the at least one CPU;
generating at least one new ACL rule that represents a new traffic flow to which said packet belongs, and wherein the at least one new ACL rule is associated with at least one parameter characterizing the new traffic flow;
storing said at least one new ACL rule at an ACL table comprised at the at least one packet processor;
determining which of a plurality of proceeding packets arriving to the network element belong to the new traffic flow, wherein the packets that belong to the new traffic flow are packets which are in conformity with said at least new ACL rule; and
retrieving statistical data associated with packets determined as packets that belong to the new traffic flow and applying the retrieved statistical data for monitoring the new traffic flow.
